(19) United States
(12) Patent Application Publication
(10) Pub. No.: US 2026/0126758 A1
(43) Pub. Date: May 7, 2026

(54) TIMEPIECE STAFF

(71) Applicant: ROLEX SA, Geneva (CH)

(72) Inventors: Daniel Moille, Yvoire (FR); Blaise Fracheboud, Plan-les-Ouates (CH)

(73) Assignee: ROLEX SA, Geneva (CH)

(21) Appl. No.: 19/117,974

(22) PCT Filed: Oct. 3, 2023
(86) PCT No.: PCT/EP2023/077365

§ 371 Date: Apr. 16, 2025

(30) Foreign Application Priority Data
Oct. 3, 2022 (EP) 22199410.6

(51) Int. Cl. G04B 15/14; G04B 31/008

(52) U.S. Cl. CPC G04B 15/14; G04B 31/008

(57) ABSTRACT

The timepiece shaft (1), in particular a shaft for a balance (2) or a shaft for an escapement wheel or a pallet shaft, includes at least one pivot (12). The timepiece shaft (1) has a surface of revolution about a first rotation axis (A1) the generatrix (G) of which in a plane (P) passing through the first rotation axis (A1) is curved, this surface of revolution extending at least at the level of the pivot, the pivot being defined as the zone of the timepiece shaft (1) intended to come into contact with a pivot bearing (50), in particular with a pivot jewel (50).

The invention concerns a timepiece shaft. The invention also concerns an element intended to be mounted on a timepiece shaft. The invention also concerns an assembly comprising a shaft of this kind and/or an element of this kind. The invention further concerns an assembly comprising a shaft of this kind or an element of this kind or an assembly of this kind. The invention further concerns a timepiece movement comprising a shaft of this kind or an element of this kind or an assembly of this kind or a combination of this kind. The invention finally concerns a timepiece comprising a shaft of this kind or an element of this kind or an assembly of this kind or a combination of this kind or a timepiece movement of this kind.

A great deal of work and numerous patent applications are aimed at identifying a material and/or a geometry for the shafts of the movement that are both paramagnetic and resistant to mechanical loads when worn. This research relates in particular to the balance shafts, which are particularly heavily loaded. Historically, timepiece shafts are made of carbon steel, which is ferromagnetic. Paramagnetic alloys tested until now clearly offer poorer performance from a mechanical point of view. The mechanical strength of timepiece shafts therefore continues to be a problem.

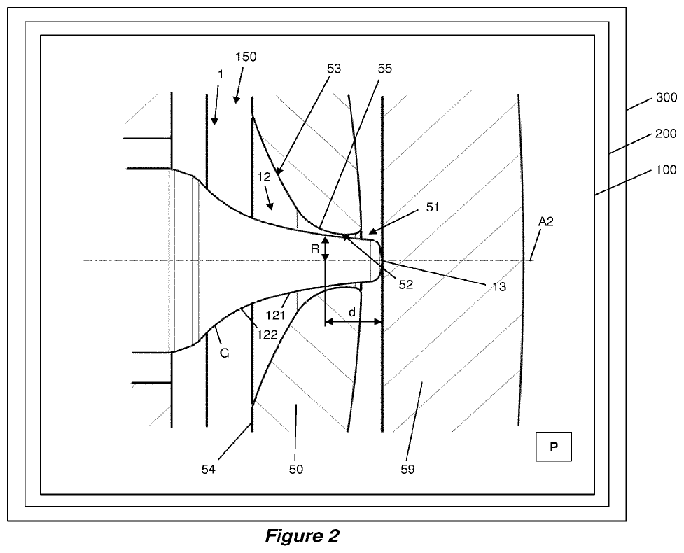

The document WO2021032552A1 describes a particular hole geometry for a pivot jewel. A pivot is schematically represented in FIG. 2 with a frustoconical geometry, but not specified further.

The document CH702314 describes a specific pivot geometry with a conical pivot that cooperates with a counter-pivot jewel surface in the form of an inverted pyramid.

The document CH704770 describes different geometries of the end of a pivot that cooperates with a counter-pivot jewel. In the vertical position of the movement a portion of the cylindrical surface of the pivot is in contact with the internal surface of the bearing. In a horizontal position of the movement the end of the pivot bears against the counter-pivot jewel. The document CH704770 is particularly concerned with the geometry of the end, proposing to misalign from the pivot axis the bearing point of the timepiece shaft on the counter-pivot jewel.

The document EP3258325 discloses a ceramic balance shaft. The pivot-shank and the pivot may be one and the same or not be delimited by a clear boundary such as a bearing surface. The pivot-shank and the pivot can for example be separated by a frustoconical surface or a surface with a curved generatrix. The shaft has a standard geometry at the level of its median part with receiving portions for a plate (cylindrical portion), a balance with a receiving seat forming an abutment and a cylindrical portion and a collet that is not represented.

The standard NIHS-34-01 describes standard balance shaft geometries. The shaft comprises a plurality of portions, in particular cylindrical portions, bearing surfaces perpendicular to the axis of symmetry forming abutments, and frustoconical portions. These frustoconical portions are not bearing or abutment surfaces, however, but entry chamfer surfaces to facilitate assembly of the components mounted on the shaft and/or machining. In particular, the plate and the balance are driven so as to bear on the plane or substantially plane surfaces of the seating. The pivots are described as being of cylindrical shape with diameter p, extended by a cone or by a surface of revolution evolving into a circular arc of radius r.

A. Haag, in “Theoretische und experimentelle Untersuchungen zum Verhalten der Unruhzapfen bei Stoessen auf die Uhr” (Actes du Congrès International de Chronométrie 1964, p. 1125), describes a general plane of a balance shaft with plane bearing or abutment surfaces and conical receiving portions that form a driving cone. This type of cone is used because it ensures very good centering and facilitates assembly. The driving cone (sometimes termed a Morse cone) rests on nested male and female elements the conical walls of which typically have cone angles of a few degrees and is used to fix parts together in fields such as the machine tools industry and dental applications.

The document CH327357 describes a shaft geometry designed to facilitate demounting of the various elements. The shaft includes a cylindrical receiving portion, optionally with a conical portion with a small cone angle and/or a shoulder. The various elements are driven with corresponding bores onto the cylindrical portions.

The document CH715867 describes a shaft geometry including a plurality of straight frustoconical sections. The object of these parts is to facilitate the driving of the various elements mounted on the shaft (collet of the balance-spring, balance, plate) and/or machining of the shaft, but they do not constitute bearing or abutment surfaces for the mounted elements. To the contrary, the collet and the plate come to bear on plane surfaces forming shoulders, i.e. forming plane bearing surfaces perpendicular to the axis of revolution of the shaft.

The document FR2268291 describes a balance shaft geometry optimized for producing the shaft from drawn wire, with no retaining or bearing or abutment surface for the balance or the plate.

The illustrated professional dictionary of horology (G.-A. Berner) indicates that one type of pivot is incorrectly termed “conical”. It would better be termed a pivot without bearing surface. It is formed by a cylindrical part connected to the pivot shank by a radius. It is part of a timepiece shaft with its end bearing against the face of a counter-pivot jewel. The bearing surface being eliminated, friction is reduced.

C. Schlatter and H.-A. Lehmann, in “Mesures de la fragilité des pivots d'axes de balancier” (actes du 46^{e} congrès de la Société Suisse de Chronométrie, p. 157, 1971), measure the resistance to bending of various pivot geometries. A continuous connection between the cylindrical part (the pivot) and the conical part is recommended. Moreover, tests with “rounded cone” (radius) geometries are more favorable than cone geometries as such for connecting the cylindrical pivot portion to the pivot-shank.

The object of the invention is to provide a timepiece shaft remedying the problems referred to above and enabling improvement of the timepiece shafts known from the prior art. In particular, the invention proposes a timepiece shaft the mechanical strength of which is improved.

In accordance with a first aspect of the invention, objects are defined by the following propositions.
1. Timepiece shaft 1, in particular a shaft for a balance 2 or a shaft for an escapement wheel or a pallet shaft:
   having a first rotation axis A1, and
   including at least one pivot 12,
      the timepiece shaft 1 having a surface of revolution about the first rotation axis A1 the generatrix G of which in a plane P passing through the first rotation axis A1 is curved, this surface of revolution extending at least at the level of the pivot, the pivot being defined as the zone of the timepiece shaft 1 intended to come into contact with a pivot bearing 50, in particular with a pivot jewel 50.
2. Timepiece shaft 1 according to proposition 1, wherein:
   the generatrix G has at all points a radius of curvature less than 2 mm, in particular less than 1.8 mm, and/or
   the diameter of the cross section of the surface of revolution increases continuously in the direction away from the proximal end 13 of the timepiece shaft 1, and/or
   the generatrix G has a radius of curvature decreasing in the direction away from the proximal end 13 of the timepiece shaft 1.
3. Timepiece shaft 1 according to either one of propositions 1 or 2 wherein the generatrix G has, at the level of the pivot, a first portion 121 seen as convex from the first rotation axis A1.
4. Timepiece shaft 1 according to either one of propositions 1 or 2 wherein the generatrix G has, at the level of the pivot, a first portion 121 seen as concave from the first rotation axis A1.
5. Timepiece shaft 1 according to proposition 4 wherein the distance R from the first portion to the first rotation axis A1 increases in accordance with the following law as a function of the distance d to the proximal end 13 of the timepiece shaft 1: R=A×(d+B)^{1/3}, with A and B constant numbers.
6. Timepiece shaft 1 according to proposition 3 or 4 wherein the first portion 121 is a portion of a circle having a first radius of curvature R 1.
7. Timepiece shaft 1 according to any one of propositions 3 to 6 wherein the generatrix G has a second portion 122 seen as convex from the first rotation axis A1, the first and second portions being continuously connected, in particular continuously connected in tangency and/or continuously connected in curvature.
8. Timepiece shaft 1 according to proposition 7 wherein the second portion 122 is a portion of a circle having a second radius of curvature R2.
9. Timepiece shaft 1 according to any one of propositions 1 to 8 wherein the generatrix G consists of a spline curve or portions of spline curves continuously connected, in particular continuously connected in tangency and/or continuously connected in curvature.
10. Timepiece shaft 1 according to any one of propositions 1 to 9 wherein the timepiece shaft includes a plurality of surfaces of revolution and the surfaces of revolution of the timepiece shaft 1 about the first rotation axis A1 each have a generatrix which, in a plane P passing through the first rotation axis A1, has a radius of curvature greater than 40 μm or 50 μm at all points on the generatrix.
11. Timepiece shaft 1 according to any one of propositions 1 to 10 wherein the timepiece shaft 1 is made of:
   a technical ceramic, in particular zirconia or alumina, or
   a glass, in particular a metallic glass, or
   a steel, in particular a carbon steel, or
   a paramagnetic austenitic steel, or
   a metal alloy, or
   a high-entropy alloy, or
   a composite material, in particular a composite material including a ceramic charge in a metal matrix.
12. Assembly 150, in particular assembled balance 150, including a timepiece shaft 1 in accordance with any one of propositions 1 to 11.
13. Combination 100 including:
   a timepiece shaft 1 according to any one of propositions 1 to 11 or an assembly 150 according to proposition 12, and
   a pivot bearing 50, in particular a pivot jewel 50.
14. Combination 100 according to proposition 13 wherein the pivot bearing 50 includes a pivot jewel 50 including a hole 51 along a second rotation axis A2 for pivoting of the timepiece shaft 1, the hole including:
   a first zone 52 in which the timepiece shaft 1 pivots, and
   a second clearance zone 53 extending from a first face 54 of the bearing to the first pivot zone 52,
      the face 54 being perpendicular or substantially perpendicular to the second rotation axis A2 and designed to be oriented on the side of the body of the timepiece shaft 1, the first pivot zone 52 and the second clearance zone 53 being connected to one another by a connecting rounding 55.
15. Combination 100 according to proposition 14 wherein the second clearance zone 53 has a maximum diameter greater than twice or greater than four times or greater than six times the minimum diameter of the first pivot zone 52.
16. Timepiece movement 200 including a timepiece shaft 1 according to any one of propositions 1 to 11 and/or an assembly according to proposition 12 and/or a combination according to any one of propositions 13 to 15.
17. Timepiece 300, in particular a wristwatch, including a timepiece movement 200 according to proposition 16 and/or a timepiece shaft 1 according to any one of propositions 1 to 11 and/or an assembly according to proposition 12 and/or a combination according to any one of propositions 13 to 15.

In accordance with a second aspect of the invention, objects are defined by the following propositions.
18. Timepiece shaft 1 including a first portion 24 for driving an element 2; 3; 4 along a driving axis A1, the timepiece shaft 1 having a geometry:
having a first frustoconical abutment portion 21 adapted to halt an element 2; 3; 4 during driving thereof onto the timepiece shaft 1, the first abutment portion 21 having a half-angle at the apex between 30° and 60° inclusive and such that the distance L measured along the driving axis A1 and separating the first driving portion 24 from the first abutment portion 21 is at least 0.05 mm, even at least 0.1 mm.
19. Timepiece shaft 1 according to proposition 18 wherein the timepiece shaft is a shaft for a balance 2.
20. Timepiece shaft 1 according to either one of propositions 18 and 19 wherein the first driving portion 24 and the first abutment portion 21 are separated by a separation portion 25 having a diameter less than that of the first driving portion 24.
21. Timepiece shaft 1 according to proposition 20 wherein the first driving portion 24 and the separation portion 25 are connected by one or more radii and/or the first abutment portion 21 and the separation portion 25 are connected by one or more radii.
22. Timepiece shaft 1 according to any one of propositions 18 to 21 wherein the timepiece shaft 1 is made of:
   a technical ceramic, in particular zirconia or alumina, or
   a glass, in particular a metallic glass, or
   a steel, in particular a carbon steel, or
   a paramagnetic austenitic steel, or
   a metal alloy, or
   a high-entropy alloy, or
   a composite material, in particular a composite material including a ceramic charge in a metal matrix.
23. Timepiece shaft 1 according to any one of propositions 18 to 22 wherein the timepiece shaft 1 has a geometry of revolution about the driving axis A1.
24. Timepiece shaft 1 according to any one of propositions 18 to 23 wherein the timepiece shaft 1 has surfaces of revolution about the driving axis A1 and the surfaces of revolution each have a generatrix which, in a plane P passing through the driving axis A1, has a radius of curvature greater than 40 μm or 50 μm at all points on the generatrix.
25. Timepiece shaft 1 according to any one of propositions 18 to 24 wherein the timepiece shaft 1 includes at least one pivot 12, preferably two pivots.
26. Element 2; 3; 4 intended to be driven onto a timepiece shaft 1 along a driving axis A1, the element 2; 3; 4 including:
   a second portion 34 adapted to be driven onto a timepiece shaft 1, and
   a second frustoconical abutment portion 31 adapted to halt the element 2; 3; 4 during driving thereof onto a timepiece shaft 1, the second abutment portion having a half-angle at the apex between 30° and 60° inclusive, the distance L measured along the driving axis A1 between the second driving portion 34 and the second abutment portion 31 being at least 0.05 mm, even at least 0.1 mm.
27. Element 2; 3; 4 according to proposition 26 wherein the element 2; 3; 4 is a balance 2 or a plate or a double plate 3 or a collet 4.
28. Element 2; 3; 4 according to proposition 26 or 27 wherein the element 2; 3; 4 includes a recessing 35 between the second driving portion 34 and the second abutment portion 31.
29. Assembly 150, in particular an assembled balance 150, including:
   a timepiece shaft 1, in particular a timepiece shaft 1 according to any of propositions 18 to 25, and
   an element 2; 3; 4 driven onto the timepiece shaft 1, in particular an element 2; 3; 4 according to any one of propositions 26 to 28.
30. Timepiece movement 200 including:
   a timepiece shaft 1 according to any one of propositions 18 to 25, and/or
   an element 2; 3; 4 according to any one of propositions 26 to 28, and/or
   an assembly according to proposition 29.
31. Timepiece 300, in particular a wristwatch, including:
   a timepiece movement 200 according to proposition 30, and/or
   a timepiece shaft 1 according to any one of propositions 18 to 25, and/or
   an element 2; 3; 4 according to any one of propositions 26 to 28, and/or
   an assembly 150 according to proposition 29.

In accordance with a third aspect of the invention, objects are defined by the following propositions.
32. Assembly 150, in particular an assembled balance 150, comprising:
   a timepiece shaft 1, and
   an element 2; 3; 4 driven onto the timepiece shaft 1,
      the timepiece shaft 1 having a first driving portion 24 and a first abutment portion 21 arranged to halt the element 2; 3; 4 during its driving onto the timepiece shaft 1, the element 2; 3; 4 having a second driving portion 34 on the timepiece shaft 1 and a second abutment portion 31 arranged to halt the element 2; 3; 4 during its driving onto the timepiece shaft 1,
      the first driving portion 24 and the first abutment portion 21 being separated by a separation portion 25 having a diameter less than that of the first driving portion 24, and/or
      the element 2; 3; 4 comprising a recess 35 between the second driving portion 34 and the second abutment portion 31.
33. Assembly 150 according to proposition 32, characterized in that the first abutment portion 21 is frustoconical and has, for example, a half-angle at the apex between 30° and 60° inclusive and/or in that the distance L, measured along the driving axis A1 and separating the first driving portion 24 from the first abutment portion 21, is at least 0.05 mm, or even at least 0.1 mm.
34. Assembly 150 according to proposition 32 or 33, characterized in that the timepiece shaft is a shaft for a balance 2.
35. Assembly 150 according to any one of propositions 32 to 34, characterized in that the first driving portion 24 and the separation portion 25 are connected by one or more radii and/or in that the first abutment portion 21 and the separation portion 25 are connected by one or more radii.
36. Assembly 150 according to any one of propositions 32 to 35, characterized in that the timepiece shaft 1 is made of:
   a technical ceramic, in particular zirconia or alumina, or
   a glass, in particular a metallic glass, or
   a steel, in particular a carbon steel, or
   a paramagnetic austenitic steel, or
   a metal alloy, or
   a high-entropy alloy, or
   a composite material, in particular a composite material including a ceramic charge in a metal matrix.
37. Assembly 150 according to any one of propositions 32 to 36, characterized in that the timepiece shaft 1 has a geometry of revolution about the driving axis A1.
38. Assembly 150 according to any one of propositions 32 to 37, characterized in that the timepiece shaft 1 has surfaces of revolution about the driving axis A1 and in that the surfaces of revolution each have a generatrix which, in a plane P passing through the driving axis A1, has a radius of curvature greater than 40 μm or 50 μm at all points on the generatrix.
39. Assembly 150 according to any one of propositions 32 to 38, characterized in that the timepiece shaft 1 includes at least one pivot 12, preferably two pivots.
40. Assembly 150 according to any one of propositions 32 to 39, characterized in that the second abutment portion is frustoconical and has a half-angle at the apex between 30° and 60° inclusive and/or in that the distance L, measured along the driving axis A1 between the second driving portion 34 and the second abutment portion 31, is at least 0.05 mm, or even at least 0.1 mm.
41. Assembly 150 according to any one of propositions 32 to 40, characterized in that the element 2; 3; 4 is a balance 2 or a plate or a double plate 3 or a collet 4.
42. Timepiece movement 200 comprising an assembly according to any one of propositions 32 to 41.
43. Timepiece 300, in particular a wristwatch, comprising:
   a timepiece movement 200 according to proposition 42, and/or
   an assembly 150 according to any one of propositions 32 to 41.

If there is no logical or technical incompatibility, any combination of the features of the first, second and third aspects may be envisaged.

The appended drawings represent by way of example two embodiments of a timepiece according to the invention.

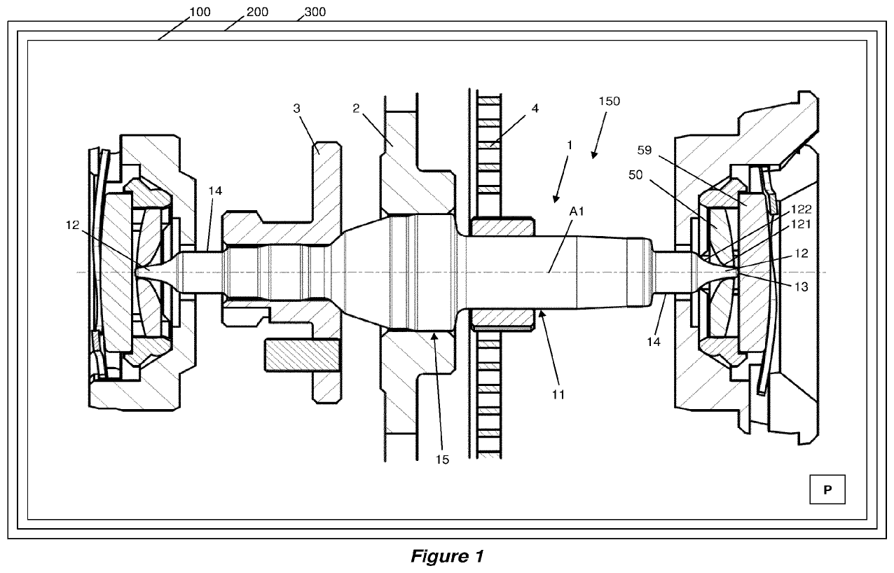

FIG. 1 is a diagrammatic view of a first embodiment of a timepiece according to the invention.

FIG. 2 is a part-sectional detail view of the first embodiment at the level of a pivot.

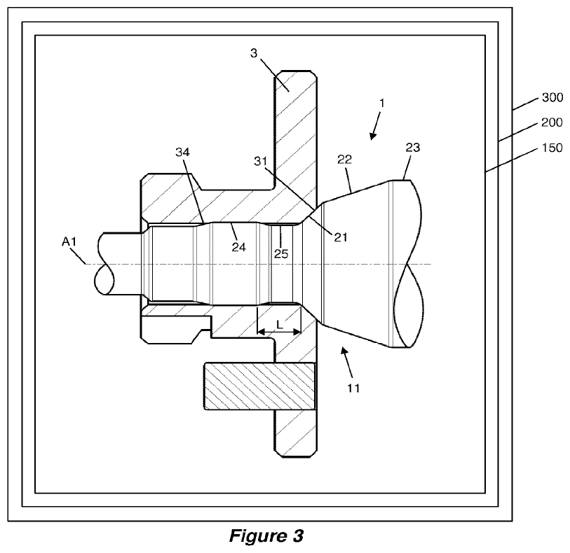

FIG. 3 is a part-sectional detail view of the first embodiment at the level of the assembly of a double-plate onto a timepiece shaft.

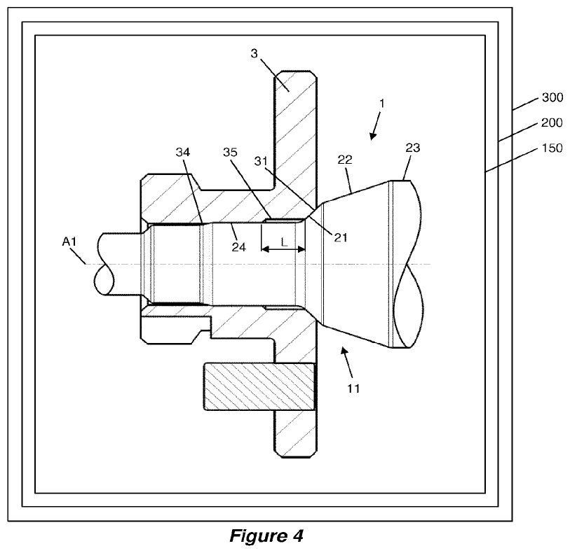

FIG. 4 is a part-sectional detail view of a second embodiment of a timepiece according to the invention at the level of the assembly of a double-plate onto a timepiece shaft.

A first embodiment of a timepiece 300 is described in detail hereinafter with reference to FIGS. 1 to 3.

The timepiece 300 is for example a watch, in particular a wristwatch. The timepiece 300 includes a timepiece movement 200 intended to be mounted in a timepiece case in order to protect it from the external environment.

The timepiece movement 200 may be a mechanical movement, in particular an automatic movement, or a hybrid movement. Alternatively, the movement may be an electronic movement.

The timepiece movement 200 includes an assembly 150 including:
a timepiece shaft 1, and
an element 2; 3; 4 mounted on, in particular driven onto, the timepiece shaft 1.

The timepiece movement 200 includes a combination 100 including:
the timepiece axis 1 or the assembly 150, and
a pivot bearing 50, in particular a pivot jewel 50.

The pivot bearing 50 may comprise the pivot jewel 50 and a counter-pivot jewel 59. The pivot jewel 50 and the counter-pivot jewel 59 may form part of a shock absorber system.

The pivot jewel 50 preferably includes a hole 51 about a second rotation axis A2 for the pivoting of the timepiece shaft 1. The hole 51 advantageously includes:
a first zone 52 for pivoting the timepiece shaft 1, and
a second clearance zone 53 extending from a first face 54 of the bearing, in particular of the pivot jewel 50, to the first pivot zone 52,
   the face 54 being perpendicular or substantially perpendicular to the second rotation axis A2 and designed to be oriented on the side of a body 15 of the timepiece shaft 1, the first pivot zone 52 and the second clearance zone 53 being connected to one another by a connecting rounding off 55.

Preferably, the first pivot zone 52 is configured so as to have a minimum diameter located away from both ends of the hole, in particular from the face 54 and from another face of the jewel 50 opposite to the face 54. In other words, the bearing zone of the timepiece shaft 1 on the pivot jewel 50 is not located at an edge of the hole 51. Preferably, the counter-pivot jewel 59 comprises a flat contact surface intended to cooperate with the end 13 of the timepiece shaft 1.

Using a pivot jewel of this kind with a clearance zone 53 of this kind enables improvement of performance by minimizing pivot play and the risk of the timepiece shaft 1 jamming in the pivot jewels 50 when using a timepiece shaft 1 with optimized pivot geometry as described later. Indeed, surprisingly, the clearance zone 53 makes it possible to minimize the risk of jamming of a timepiece shaft 1 whose diameter increases (along its geometric axis A1) more significantly than that of a timepiece shaft with a standard geometry.

The second clearance zone 53 advantageously has a maximum diameter greater than twice or greater than four times or greater than six times the minimum diameter of the first pivot zone 52.

The assembly may be:
an assembled balance including a balance shaft, or
an assembled escapement wheel including an escapement wheel shaft, or
an assembled escapement mobile including an escapement mobile shaft, or
an assembled pallet assembly including a pallet shaft, or
an assembled pallet mobile including a pallet mobile shaft.

Assuming an assembled balance, the element or elements may be:
a balance 2, and/or
a plate 3, in particular a double-plate, and/or
a collet 4, in particular a collet for a spiral spring.

In accordance with the first aspect of the invention the timepiece shaft 1:
preferably has a first rotation axis A1, and
preferably includes at least one pivot 12,
   the timepiece shaft 1 having a surface of revolution about the first rotation axis A1 the generatrix G of which in a plane P passing through the first rotation axis A1 is curved. This surface of revolution extends at least at the level of the pivot, the pivot being defined as the zone of the timepiece shaft 1 intended to come into contact with the pivot jewel 50.

Alternatively or additionally, in accordance with the second aspect of the invention, the timepiece shaft 1 includes a first portion 24 for driving an element 2; 3; 4 along a driving axis A1, the timepiece shaft 1 having a geometry:
including a frustoconical first abutment portion 21 adapted to halt an element 2; 3; 4 during its driving onto the timepiece shaft 1, the first abutment portion 21 having a half-angle at the apex (the apex of the cone extending the frustoconical surface) between 30° and 60° inclusive, and such that the distance L measured along the driving axis A1 between the first driving portion 24 and the first abutment portion 21, that is to say separating the first driving portion 24 from the first abutment portion 21, is at least 0.05 mm, even at least 0.1 mm.

The first embodiment represented in FIGS. 1 to 3 combines these two aspects of the invention.

The first rotation axis A1 and the driving axis A1 preferably coincide. For this reason the two axes have been represented as coinciding and bear the same reference A1. Furthermore, ignoring functional clearances, the first rotation axis A1 and the second rotation axis A2 also coincide.

The shaft 1 advantageously includes at each of its ends a pivot 12. Each pivot 12 is preferably connected to the body 15 by a pivot-shank 14.

In the case of a balance, the shaft has different functions. On the one hand, the pivots 12 placed at the ends of the shaft enable pivoting of a balance/balance-spring combination in cooperation with the bearings. To guarantee good performance over time, this function requires:
high mechanical strength,
where its roughness is concerned, a very polished surface state, and
a very small diameter.

Furthermore, the shaft 1 carries components of the balance/balance-spring, like:
the balance, which forms a wheel of given inertia,
the balance-spring, which exerts a return torque on the oscillating combination,
the collet driven or assembled onto the shaft 1 and that fixes the balance-spring, or
the single or double plate, which interacts for example with a pallet assembly of an escapement by means of a pin for on the one hand unlocking the escapement and on the other hand receiving a pulse for maintaining the oscillation of the balance/balance-spring. The plate is a double plate when it includes, in addition to the plate carrying the pin, an additional stage, generally of smaller diameter, provided with a cut-out that interacts with a barb of the pallet assembly to form an anti-overturning system that prevents untimely unlocking of the escapement.

For example, each end 13 of the timepiece shaft 1, designed in particular to come into contact against a counter-pivot jewel 59, is not part of a pivot 12. A counter-pivot jewel 59 of this kind is provided to delimit the longitudinal movement of the timepiece shaft 1 and not to enable pivoting of the latter. The counter-pivot jewel 59 therefore does not constitute a pivot jewel.

Each end 13 of the timepiece shaft 1 may be:
convex and rounded, or
flat, or
concave,
   so as to come into contact with the counter-pivot jewel 59.

For example, from the point on the surface of the timepiece shaft having the most extreme abscissa relative to the axis A1, that is to say from the extreme point of the timepiece shaft 1, the limit between the end 13 and the pivot 12 is located at those places where the plane tangential to the surface of the timepiece shaft 1 is at an angle to the axis A1 less than 10°.

For example, the limit between a connecting zone and a pivot 12 is formed by a plane at a distance of 50 μm or 210 μm or 250 μm from the end of the shaft.

On moving on the surface of the timepiece shaft from one extreme point (one end) of the timepiece shaft 1 to another extreme point (another end) of the timepiece shaft, there are successively encountered:
an end 13,
a pivot 12,
a connecting zone connecting the pivot to a pivot-shank, and
a pivot-shank 14.

The connecting zone includes a surface of revolution portion obtained by revolution of a portion 122 of the generatrix curve G.

The work of the inventors shows, surprisingly, that the shape of the pivots must be re-imagined because of the nature of the material used. Rules based on experience and empirical modifications in respect of high-hardness metal alloys do not necessarily apply to a shaft made of high-performance technical ceramic such as an yttrium zirconium oxide shaft of type 2YZ or 3YZ in particular. This approach applies to the shape of the pivots but also to the geometry of the central part 15 (or body 15) of the shaft 1 onto which the various elements mounted on the balance are assembled.

Thus it has been found that the traditional geometry of the pivots is prejudicial to their mechanical strength when a ceramic type material is used. There is needed on the one hand an evolution of the profile to be as a continuous as possible, avoiding any edge or abrupt change of dimension. In fact, simulations carried out show that each corner and/or edge and/or abrupt change of dimension induces a concentration of stresses that must be prevented.

The fact of redefining the transitions between the various parts or zones of the shaft, in particular avoiding bearing surfaces perpendicular to the rotation axis A1 and edges, enables improvement of impact resistance and limitation of breakages. This breaks with the traditional shapes seen in the illustrated professional dictionary of horology (G.-A. Berner), even in the application EP3594757 which however concerns a shaft made of injectable material, like ceramic. From the point of view of the dimensions, the work of the inventors shows that it is necessary to adapt the radii of curvature in the connecting zones to minimize the stresses, in particular to have radii greater than 40 μm, ideally greater than 50 μm. This first adjustment of the connecting radii enables a significant reduction in the stress levels in the ceramic material: in batches produced under equivalent conditions (machining conditions and parameters, product range) there has been measured an increase in the force at rupture when loaded in bending at three points (with the point on which the force bears on the receiving zone of the balance) and a reduction of the number of shafts broken by standardized impacts:
during a first series of tests on ten parts, the radius of curvature in the connecting zones was increased from 35 μm to 55 μm and resulted in an increase in the force at rupture from 12 N to 16 N and a very significant reduction in the percentage of shafts broken, from 50% to 0%;
during a second series of tests on ten parts, the radius of curvature in the connecting zones was increased from 10 μm to 55 μm and resulted in an increase in the force at rupture from 7-10 N to 15 N and a very significant reduction in the percentage of shafts broken, from 70% to 0%.

Increasing the radius to 40 μm, or even to greater than 50 μm, therefore enables a 50% improvement in terms of the force at rupture and prevents the shaft breaking in the event of impacts with the assembled balance when in movement.

The pivots, which take the forces exerted on the balance/balance-spring, are the most critical functional parts. As mentioned above the pivots cooperate with the bearings to ensure the most regular and effective possible oscillation of the balance/balance-spring by minimizing friction losses (the same applies to the rotation of the escapement wheel or the to-and-fro of the pallet assembly). The friction losses, and consequently the accuracy of the watch, will be all the better if the diameter at the level of the pivots is small. On the other hand, a small diameter results in low mechanical strength and therefore high sensitivity to impacts. For most metal alloys used for the shafts, and in particular non-magnetic alloys, the behavior in deformation exhibits a range of plastic deformation: an impact can produce an irreversible deformation, which leads to defective concentricity of the shaft and a deterioration of chronometric performance. A ceramic shaft will not be deformed plastically (or very little so) and excessive deformation leads to the shaft breaking and the watch stopping. Thus there is a compromise to be found between the accuracy of the watch (smallest possible diameter) and the mechanical strength of the shaft (largest possible diameter). Obtaining a functional ceramic shaft resistant to the loads on the watch under demanding conditions is therefore a real challenge.

As mentioned above, first parts 13 (ends of the timepiece shaft 1) make the contact with the counter-pivot jewel 59. This contact occurs for example in horizontal positions of the movement (rotation axis of the shaft parallel to terrestrial gravity).

As mentioned above, the second parts 12 (pivots 12) provide the contact of the shaft 1 with the pivot jewel 50, on which the surfaces of the pivots come to bear, in particular in vertical and inclined positions of the movement.

Each of the pivots includes a first surface of revolution portion (obtained by revolution of a first portion 121 of generatrix curve G) that is, as mentioned above, intended to come into contact with a pivot jewel 50.

The shaft 1 further includes at least one connecting zone including a second surface of revolution portion (obtained by revolution of a second portion 122 of the generatrix curve G). Each connecting zone enables a pivot to be connected to a pivot-shank 14 or directly to the body 15 of the shaft 1 in the absence of a pivot-shank. Research shows that these connecting zones are important for mechanical strength.

In accordance with the prior art the axial sections (with respect to the axis A1) of the first surface portion are rectilinear: the first surface portions are cylindrical or frustoconical. This geometry is largely due to the machining process used to produce the pivots, and in particular a rolling process, which allows no freedom to produce varied shapes. According to the invention, the use of laser machining enables production of first surface parts with axial sections (with respect to the axis A1) of the first surface portion that are not rectilinear.

In a first variant the generatrix G has at every point a radius of curvature less than 2 mm, in particular less than 1.8 mm.

In a second variant, possibly combinable with the first variant, the diameter of the cross section of the surface of revolution increases continuously in the direction away from the proximal end 13 of the timepiece shaft 1 and toward the distal end of the timepiece shaft 1. The proximal end of the timepiece shaft 1 is the end 13 of the shaft that is closest to the surface of revolution (along the axis A1). The distal end of the timepiece shaft 1 is the end 13 of the shaft that is at the greatest distance from the surface of revolution (along the axis A1).

In accordance with a third variant, possibly combinable with the first and/or second variant, the generatrix G has a radius of curvature decreasing in the direction away from the proximal end 13 of the timepiece shaft 1 and approaching the distal end of the timepiece shaft 1 (along the axis A1).

In one particular embodiment the generatrix G may include at the level of the pivot a first portion 121 seen as convex from the first rotation axis A1. The tangents to the first portion are located between the first portion and the axis A1. The second derivative of the first portion 121 with respect to the axis A1 in the direction away from the proximal end of the timepiece shaft 1 and approaching the distal end of the timepiece shaft 1 is strictly positive.

In an alternative embodiment the generatrix G may have at the level of the pivot a first portion 121 seen as concave from the first rotation axis A1. The first portion is located between the tangents to the first portion and the axis A1. The second derivative of the first portion 121 with respect to the axis A1 in the direction away from the proximal end of the timepiece shaft 1 or approaching the distal end of the timepiece shaft 1 is strictly negative.

In this alternative embodiment the distance R from the first portion 121 to the first rotation axis A1 preferably increases in accordance with the following law as a function of the distance d to the proximal end 13 of the timepiece shaft 1: R=A×(d+B)^{1/3}, where A and B are constant numbers. The distance R is therefore the radius of the cross section (perpendicular to the axis A1) located at the distance d from the proximal end 13 of the timepiece shaft 1. It is interesting to note that with such dimensions, the pivot could be longer without increasing the maximum stress. This would allow the pivot to bend more and enable limitation of the axial movement.

Whichever embodiment is selected from the two that have just been mentioned, the first portion 121 may be a portion of a circle or of a circular arc having a first radius of curvature R1.

Furthermore, regardless of the embodiment, the generatrix G advantageously has a second portion 122 seen as convex from the first rotation axis A1. The tangents to the second portion are located between the second portion and the axis A1. The second derivative of the second portion 122 with respect to the axis A1 in the direction away from the proximal end of the timepiece shaft 1 and approaching the distal end of the timepiece shaft 1 is strictly positive. The first and second portions are advantageously continuously connected, (same radius R of the first and second portions at the level of the connection), in particular continuously connected in tangency (same tangent at the level of the connection of the first and second portions) and/or continuously connected in curvature (same curvature at the level of the connection of the first and second portions).

The second portion 122 may be a portion of a circle or of a circular arc having a second radius of curvature R2.

As a variant of the first and second portions produced in the form of circular arcs, the generatrix G may consist of a spline curve or portions of spline curves continuously connected, in particular continuously connected in tangency and/or a continuously connected in curvature.

With geometries of the above kind tests carried out by the inventors show a very clear improvement compared to the traditional geometry, which is formed of a frustoconical pivot connected to a pivot-shank by a circular arc radius. The reduction of stresses is estimated at 10% by simulation with a comparable axial clearance of the timepiece shaft 1 in the pivot jewels.

It is further possible to reduce stresses by reducing the axial clearance.

Tests have been carried out to compare pivots optimized as described above and standard frustoconical pivots of timepiece shafts made of ZrO₂. It is apparent that that the optimized pivots enable a 24% reduction in the stresses in the timepiece shaft 1 compared to a timepiece shaft with standard pivots. Furthermore, it is apparent that the optimized pivots enable a 30% increase in the force at rupture compared to a timepiece shaft with standard pivots.

The inventors have noted that the central part (or body 15) of the timepiece shaft 1, i.e. the part 11 including in particular the rods and the seat or seating that receives the hub of the balance, the collet of the balance-spring and/or the single or double plate also includes potential zones of weakness, especially if the shaft is made of a ceramic material. It proves that the traditional elements of the construction of a balance shaft, such as bearing surfaces or abrupt changes in dimensions, weaken the strength of the shaft when it is made of ceramic material. Some characteristics, which do not pose any problem with a high-performance metal alloy, are revealed as critical points of weakness with a technical ceramic.

As for the pivots, the inventors have noted that corners and edges, which favor stress concentrations, are generally to be avoided. Geometries, in particular geometries receiving various elements assembled onto the shaft, must be optimized to reduce stress levels. Generally speaking, to minimize stresses it is necessary to use radii of curvature of at least 20 μm, preferably at least 50 μm.

A first solution to limit stresses and increase the strength of the shaft between the pivots is to use a conical bearing surface for some of the elements assembled onto the shaft, as described hereinafter in a non-limiting manner for a double-plate example.

In the case of a traditional assembly with a double-plate, the double-plate includes a bore with entry chamfers on either side that facilitate machining it and assembly by driving it onto the shaft. The double-plate is driven while bearing on a bearing surface on the timepiece shaft 1 and the chamfer does not cooperate with the shaft: there remains a space between:
the chamfer of the double-plate, and
the radius of the connection on the shaft between the receiving part and the bearing surface.

In the case of the optimized geometry, the double-plate 3 includes a frustoconical bearing surface 31 that is more extensive than a simple chamfer or a simple chamfered edge. This surface 31 comes to bear directly on a corresponding frustoconical surface 21 on the timepiece shaft 1. In order to obtain controlled positioning of the component assembled onto the timepiece shaft 1 the angles of the corresponding two surfaces are ideally identical or comparable. This arrangement enables control of the position of the double-plate with a well-defined abutment while avoiding abrupt variations of section of the balance shaft and therefore minimizing stresses in the shaft. Bearing on a cone, for example a 45° cone, also makes it possible for the double-plate to have a better impact resistance, impacts tending to cause relative movement of the timepiece shaft 1 and the double-plate 3 relative to the driving axis A1, in particular around the driving axis A1.

Tests have been carried out with a nominal height and a nominal width of the frustoconical bearing surface 31 of 0.07 mm (on the side of the assembled component) and the results are entirely satisfactory with no problems detected. The size of the frustoconical bearing surface 31 must be adapted to the strength of the material of the double-plate, because a reduction of the width of the frustoconical bearing surface 31 increases the risk of burring of the material of the double-plate in the event of an impact. This size of the frustoconical bearing surface 31 is estimated as follows:
0.05 mm width (measured along the axis A1) and/or height (measured perpendicularly to the axis A1) for heavy balances (typical inertia and dimensions for movements of large diameter ≥25 mm), and
0.04 mm width (measured along the axis A1) and/or height (measured perpendicularly to the axis A1) for light balances (movements of small diameter <25 mm).

In all cases it seems recommended that the frustoconical bearing surface 31 on the double-plate is not less than that guaranteeing no burring or only slight burring of the assembled component (for example the double-plate) in the event of axial impacts.

Where the angle of the frustoconical bearing surface 31 is concerned, the value chosen is the result of a compromise between two antagonistic requirements. To increase the strength of the shaft as gradual as possible a transition of shape or change of diameter is required, and therefore as small as possible an angle between the axis of revolution and the frustoconical surface. Overall, an angle between the axis of symmetry and the frustoconical surface ≤45° enables great reduction of stresses in the shaft in the event of a radial impact. For the assembled component there is to the contrary required as large as possible an angle to guarantee good positioning on the shaft after driving. The compromise adopted is an angle of 45° (half-angle at the apex of the cone formed by the frustoconical section). This being the case, a minimum angle of 30° (the half-angle at the apex of the cone) enables good positioning to be obtained while avoiding too marked a transition of diameter on the shaft, which would weaken the reinforcement of the shaft and the reduction of stresses and reduce the improvement compared to a standard geometry. The other requirement is less critical and will depend on the elastic strength of the material of the assembled component and the precision of the relative positioning of the various elements (for example precise chamfers on the assembled component). It is apparent that an angle of 60° may be suitable. In conclusion, the ideal angle appears to be 45° (half-angle at the apex of the cone), with a permissible range from 30° to 60° (half-angle at the apex of the cone).

This type of bearing on a cone is to be distinguished from a “Morse cone” (or driving cone) or “ISO cone” type coupling or clamping as used in other fields. In this case the cone angle of the shaft is low, of the order of 3° and less for a “Morse cone”.

A second solution for limiting stresses, which may highly advantageously be combined with the first solution, is to move the receiving or driving portion 24 of the element, for example the double-plate, away from the bearing or abutment portion 21. When mounting the element 3 on the timepiece shaft 1 the element is driven along the axis A1 on the timepiece shaft 1, in particular on the driving portion 24, and the element 3 is halted axially relative to the timepiece shaft 1 when it comes to bear against the bearing or abutment portion 21 of the timepiece shaft 1. The element 3 therefore includes:
a driving portion 34 cooperating with the receiving or driving portion 24, and
an abutment or bearing portion 31 cooperating with the abutment or bearing portion 21.

In the case of a standard geometry the driving zone is placed as close as possible to the bearing surface to facilitate machining and assembly of the components, as well as to improve the mechanical strength of the shaft.

The inventors have noted that this arrangement is unfavorable in the case of a ceramic shaft or arbor: the optimized geometry in fact aims to move the portion receiving the component 24 away from the bearing portion 21 by providing a zone 25 of smaller section between the receiving portion 24 and the bearing portion 21, which prevents any contact with and clamping of the timepiece shaft 1 in the vicinity of the bearing portion 21. This makes it possible to prevent accumulation of stresses linked to driving the element and stresses linked to the variation of section induced by the presence of the bearing zone 21. This solution is a priori counter-intuitive: in fact, measurements show that the strength of the timepiece shaft 1 alone is reduced with this optimized geometry as represented in FIG. 3. However, once the element is assembled onto the shaft, the element-shaft combination is significantly less fragile and stronger, in particular in terms of impact resistance, than an element-shaft combination known from the prior art.

The impact of the central geometry of the shaft (shaft body 15) has been characterized using batches of five components at the level of the bearing of the double-plate. A version with optimized geometry in accordance with the second aspect of the invention has been compared to a standard or traditional version (with bearing surface perpendicular to the axis A1 and adjacent to the driving portion of the double-plate). This characterization is effected by a three-point bending test on an assembled balance/balance-spring with a reaction force at the level of each pivot and a force applied at the level of the receiving portion of the balance. The force at rupture is 17.3±1.2 N for the standard version and 18.9±0.6 N for the optimized version, i.e. a statistically significant difference of 10%. This improvement is comparable to that expected following numerical simulation and enables supplementary operating security and an improved impact resistance of the ceramic balance shaft. An improvement of the same order of magnitude is found also for the mean drop height causing the balance shaft to break at the level of its central part (severe ram impact test). It is very probable that systematic optimization will enable further enhancement of the improvement obtained.

The object of the separation portion between the receiving portion 24 and the bearing portion 21 is to move apart stress zones generated on the one hand by driving and on the other hand by cross section variations, in particular when the timepiece shaft 1 is subjected to deformation in bending.

Simulations have been carried out to estimate the minimum dimension L of the separation zone. For a distance L of 0.02 mm between the receiving portion 24 and the bearing portion 21 the stress fields coincide. A separation appears for a distance of 0.05 mm, with stress reduced by 5%. The separation is clearly marked for a distance of 0.1 mm with stress reduced by 10% compared to a distance of 0.02 mm.

The presence of a groove 25 or a separation portion 25 having a diameter less than that of the first driving portion 24 and enabling separation of the first driving portion 24 and the first abutment portion 21 is therefore highly beneficial and already appears in the simulation for a distance of 50 μm, more particularly of 100 μm. This separation is produced by a groove on the shaft. The depth does not appear to be a parameter influencing the simulations carried out. The groove depth is for example 7 μm (radius difference of 7 μm between the groove 25 and the portion 24). Additionally and/or alternatively a radius difference between the bore 34 of the driven element 3 and the groove bottom may be of the order of 4 μm.

The driving portion 24 and the separation portion 25 are advantageously connected by one or more radii and/or the first abutment portion 21 and the separation portion 25 are advantageously connected by one or more radii.

A second embodiment of a timepiece according to the invention is described hereinafter with reference to FIG. 4.

The second embodiment preferably differs from the first embodiment in the geometries of the timepiece shaft 1 and the element 3 enabling separation of the portions generating stresses on the timepiece shaft 1.

The element 3 comprises:
the second driving portion 34 on the timepiece shaft 1, and
the frustoconical second abutment portion 31 for halting the element 3 when it is driven onto the timepiece shaft 1.

The second abutment portion has a half-angle at the apex between 30° and 60° inclusive and the distance L measured along the driving axis A1 separating the second driving portion 34 from the second abutment portion 31 is at least 0.05 mm, even at least 0.1 mm.

To achieve this distance the element 3 preferably includes a recess 35 between the second driving portion 34 and the second abutment portion 31 as represented in FIG. 4. As an alternative to the recess 35 a conical bored portion may be produced to connect the portions 31 and 34.

Note that with an embodiment of this kind it is not necessary to provide a groove on the timepiece shaft 1 between the portions 24 and 21.

Regardless of the embodiment or the variant, the timepiece shaft 1 is advantageously made of:
a technical ceramic, in particular zirconia or alumina, or
a glass, in particular a metallic glass, or
a steel, in particular a carbon steel, or
a paramagnetic austenitic steel, or
a metal alloy, or
a high-entropy alloy, or
a composite material, in particular a composite material including a ceramic charge in a metal matrix.

Technical ceramic materials like zirconia or alumina have mechanical characteristics and properties that are of interest for many applications. Their use for timepiece movement components is on the other hand difficult, in particular because of the challenge of obtaining small components with very close tolerances and because of the fragility of the material. These two obstacles are particularly limiting for the use of ceramics at the level of the shafts of the movement, in particular the balance shaft, although their high hardness and their paramagnetic character make them a material of choice.

Nevertheless, the shaft geometries of the solutions described above prove to be particularly suited to ceramic materials, with optimizations made at the level of the pivots and the body of the shaft that enable significant increase in the strength and the force at rupture of the shafts. These new geometries facilitate the use of ceramic shafts by guaranteeing that demanding specifications are met in respect of the impact resistance of the timepiece movement.

Regardless of the embodiment or the variant, the timepiece shaft may have a plurality of surfaces of revolution and the surfaces of revolution of the timepiece shaft 1 about the first rotation axis A1 may each have a generatrix which, in the plane P passing through the first rotation or driving axis A1, has a radius of curvature greater than 40 μm or 50 μm everywhere on the generatrix.

Regardless of the embodiment or the variant, the timepiece shaft 1 advantageously has a geometry of revolution about the driving or rotation axis A1.

Regardless of the embodiment or the variant, the abutment and/or driving portions need not be circular.

Regardless of the embodiment or the variant, the transverse dimension, in particular the diameter, of the driving portion may be between 0.2 mm and 1 mm, or even between 0.2 mm and the maximum diameter of the timepiece shaft less the width of the bearing surface 21. Preferably, the driving portion and/or the receiving portion have a cylindrical geometry, in particular with a constant or substantially constant diameter.

Preferably, regardless of the embodiment or variant, the axial dimension (measured parallel to the geometric axis A2) of:
the driving portion 24 is greater than 0.1 mm or 0.1 times, or even 0.25 times, the driving diameter, and/or
the driving portion 34 is greater than 0.1 mm or 0.1 times, or even 0.25 times, the driving diameter.

Even more preferably, regardless of the embodiment or variant, the contact between:
the driving portion 24, and
the driving portion 34
   is not linear (annular). This contact is not in the form of a curve but of a surface. The same applies to the shape of the driving portions 24 and 34.

In the embodiment shown, the abutment portions 21, 31 are conical or frustoconical. Alternatively, regardless of the embodiment or variant, the abutment portions 21, 31 may be flat.

Embodiments or variants have been described as applied to driving a double-plate onto a balance shaft. Nevertheless, the solutions described are applicable for mounting any type of element on any type of timepiece shaft, such as for example a balance-spring collet on a balance shaft, a balance on a balance shaft, a pallet plate on a pallet rod, a pallet wheel plate on an escapement wheel, or a mobile plate on a mobile shaft or pinion.

The document EP3258325A1 describes a timepiece shaft and in particular a balance shaft made of a naturally paramagnetic ceramic material. The advantage of ceramic is that the pivots are not marked in the event of severe impacts, unlike metal alloy pivots which can be plastically deformed. Furthermore, the work of the applicant of the application EP3258325A1 has shown that ceramic shafts do not wear in operation, probably thanks to their high hardness, which enables performance to be maintained over time, in contrast to most paramagnetic metal alloys.

Thanks to these solutions described above it is possible, with a ceramic material, to obtain performance equivalent to that of alloys traditionally used to produce the timepiece shafts. In fact, with the same shaft geometry the fragile behavior of a ceramic leads intrinsically to a strength less than that of the best ferromagnetic alloys like the 20AP alloy.

The development work undertaken has in particular made it possible:
by optimizing the shape of the pivots, to achieve a 25% improvement in the maximum yield stress,
by changing the design of the shaft, and in particular using gradual variations of section, large connecting radii, the introduction of a conical bearing surface for some of the elements mounted on the shaft, distancing the receiving/driving portion and the bearing portion, to increase the force at rupture by 10%.

The solutions described also enable improvement of the mechanical performance of timepiece shafts made of materials other than a ceramic.

Throughout this document by “radius” is meant, in a part of any shape, a rounding connecting two surfaces, for example two cylindrical surfaces with different diameters. What horologists call the cone of a conical pivot is in reality often a radius connecting the pivot to the rest of the timepiece shaft.

Throughout this document by “bearing surface” is meant any surface of a timepiece shaft not parallel to the longitudinal direction of that timepiece shaft and making it possible to halt an element mounted on the timepiece shaft. Unless a particular geometry is specified, by “bearing surface” is meant a plane surface perpendicular to the longitudinal direction of the timepiece shaft.

1. An assembly for an assembled balance, the assembly comprising:
a timepiece shaft, and
an element driven onto the timepiece shaft,
the timepiece shaft having a first driving portion and a first abutment portion arranged to halt the element during its driving onto the timepiece shaft,
the element having a second driving portion on the timepiece shaft and a second abutment portion arranged to halt the element during driving of the element onto the timepiece shaft, wherein
the first driving portion and the first abutment portion are separated by a separation portion having a diameter less than a diameter of the first driving portion, and/or
the element comprises a recess between the second driving portion and the second abutment portion.

2. The assembly according to claim 1, wherein
the first abutment portion is frustoconical, and/or
a distance measured along the driving axis and separating the first driving portion from the first abutment portion is at least 0.05 mm.

3. The assembly according to claim 1, wherein the timepiece shaft is a shaft for a balance.

4. The assembly according to claim 1, wherein
the first driving portion and the separation portion are connected by one or more radii, and/or
the first abutment portion and the separation portion are connected by one or more radii.

5. The assembly according to claim 1, wherein the timepiece shaft is made of:
a technical ceramic, or
a glass, or
a steel, or
a paramagnetic austenitic steel, or
a metal alloy, or
a high-entropy alloy, or
a composite material.

6. The assembly according to claim 1, wherein the timepiece shaft has a geometry of revolution about the driving axis.

7. The assembly according to claim 1, wherein the timepiece shaft has surfaces of revolution about the driving axis and the surfaces of revolution each have a generatrix which, in a plane passing through the driving axis, has a radius of curvature greater than 40 m at all points on the generatrix.

8. The assembly according to claim 1, wherein the timepiece shaft includes at least one pivot.

9. The assembly according to claim 1, wherein
the second abutment portion is frustoconical and has a half-angle at the apex in a range of from 30° and to 60°, and/or
a distance measured along the driving axis between the second driving portion and the second abutment portion is at least 0.05 mm.

10. The assembly according to claim 1, wherein the element is a balance or a plate or a double plate or a collet.

11. A timepiece movement, comprising the assembly according to claim 1.

12. A timepiece, comprising a timepiece movement according to claim 11.

13. A timepiece shaft comprising a first driving portion for driving an element along a driving axis,
the timepiece shaft having a geometry comprising a frustoconical first abutment portion arranged to halt an element during driving of the element onto the timepiece shaft,
the first abutment portion having a half-angle at the apex in a range of from 30° to 60°,
so that a distance measured along the driving axis and separating the first driving portion from the first abutment portion is at least 0.05 mm.

14. The timepiece shaft according to claim 13, wherein the timepiece shaft is a shaft for a balance.

15. The timepiece shaft according to claim 13, wherein the first driving portion and the first abutment portion are separated by a separation portion having a diameter less than a diameter of the first driving portion.

16. The timepiece shaft according to claim 15, wherein
the first driving portion and the separation portion are connected by one or more radii, and/or
the first abutment portion and the separation portion are connected by one or more radii.

17. The timepiece shaft according to claim 13, wherein the shaft is made of:
a technical ceramic, in particular zirconia or alumina, or
a glass, or
a steel, or
a paramagnetic austenitic steel, or
a metal alloy, or
a high-entropy alloy, or
a composite material.

18. The timepiece shaft according to claim 13, wherein the timepiece shaft has a geometry of revolution about the driving axis.

19-43. (canceled)

44. The assembly according to claim 5, wherein the timepiece shaft is made of a composite material including a ceramic charge in a metal matrix.

45. The assembly according to claim 8, wherein the timepiece shaft includes at least two pivots.
